(19) United States
(12) Patent Application Publication
(10) Pub. No.: US 2025/0316872 A1
(43) Pub. Date: Oct. 9, 2025

(54) BATTERY PACK

(71) Applicant: Samsung SDI Co., Ltd., Yongin-si (KR)

(72) Inventor: Sanghun Park, Yongin-si (KR)

(21) Appl. No.: 18/987,609

(22) Filed: Dec. 19, 2024

(30) Foreign Application Priority Data
Apr. 9, 2024 (KR) 10-2024-0047859

(51) Int. Cl. H01M 50/691; H01M 50/258

(52) U.S. Cl. CPC H01M 50/691; H01M 50/258

(57) ABSTRACT

A battery pack includes: a battery cell; a lower housing having an accommodation portion accommodating the battery cell, a first side wall extending around a periphery of the battery cell and defining the accommodation portion, and a second side wall extending around a periphery of the first side wall; a first upper housing covering the accommodation portion from above and coupled to the first side wall; and a second upper housing covering the first upper housing from above and coupled to the second side wall. An upper end of the first side wall is above an upper end of the second side wall.

### CROSS-REFERENCE TO RELATED APPLICATION

The present application claims priority to and the benefit of Korean Patent Application No. 10-2024-0047859, filed on Apr. 9, 2024, in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

Secondary batteries are designed to charged and discharged multiple times to provide repeated use. Secondary batteries are used as energy sources for mobile devices, electric vehicles, hybrid vehicles, electric bicycles, uninterruptible power supplies, and the like. Depending on the type of external device to which the secondary battery is to be applied (or connected), the secondary battery may be in the form of a single battery or a module, in which a plurality of batteries are connected together to form one unit.

### SUMMARY

Embodiments of the present disclosure provide a battery pack having a dual waterproof seal around an accommodation portion at where battery cells are accommodated.

Embodiments of the present disclosure provide a battery pack that may discharge a fluid flowing into a battery pack to the outside.

Additional aspects and features of the present disclosure will be set forth, in part, in the description that follows and, in part, will be apparent from the description or may be learned by practice of the described embodiments of the present disclosure.

A battery pack, according to an embodiment of the present disclosure, includes a battery cell, a lower housing having an accommodation portion accommodating the battery cell, a first side wall extending around a periphery of the battery cell and defining the accommodation portion, and a second side wall extending around a periphery of the first side wall, a first upper housing covering the accommodation portion from above and coupled to the first side wall, and a second upper housing covering the first upper housing from above and coupled to the second side wall. An upper end of the first side wall is above an upper end of the second side wall.

The height at which the first upper housing is coupled to the first side wall may be different from the height at which the second upper housing is coupled to the second side wall.

The first upper housing may include a first coupling portion coupled to the first side wall, the second upper housing may include a second coupling portion coupled to the second side wall, and the first coupling portion may be above the second coupling portion.

The first side wall and the second side wall may be spaced apart from each other by a distance.

An air gap may be formed between the first side wall and the second side wall.

The lower housing may have a drain hole configured to discharge a fluid flowing into the air gap from the outside of the battery pack.

The drain hole may extend through an outer wall of the lower housing such that the air gap is connected to the outside of the battery pack.

The drain hole may be in a side portion of the lower housing.

The drain hole may be in a lower portion of the lower housing.

The drain hole may include a plurality of first drain holes in a side portion of the lower housing and a plurality of second drain holes in a lower portion of the lower housing.

The plurality of first drain holes and the plurality of second drain holes may extend through the lower housing in directions substantially perpendicular to each other.

### BRIEF DESCRIPTION OF THE DRAWINGS

The above and other aspects and features of embodiments of the present disclosure will be more apparent from the following description, taken in conjunction with the accompanying drawings, in which:

FIG. 1 is a perspective view of a battery pack according to an embodiment;

FIG. 2 is an exploded perspective view of the battery pack shown in FIG. 1 with a second upper housing disassembled therefrom;

FIG. 3 is an exploded perspective view of the battery pack shown in FIG. 2 with a first upper housing is disassembled therefrom;

FIG. 4 is an exploded perspective view of a battery pack according to an embodiment;

FIG. 5 is a cross-sectional view of the battery pack shown in FIG. 2 taken along the line A-A;

FIG. 6 is a cross-sectional view of the battery pack shown in FIG. 2 taken along the line B-B; and

FIG. 7 is a perspective bottom view of a lower housing of a battery pack according to an embodiment.

### DETAILED DESCRIPTION

Reference will now be made, in detail, to embodiments, examples of which are illustrated in the accompanying drawings. In this regard, the described embodiments may have different forms and should not be construed as being limited to the descriptions set forth herein. Accordingly, embodiments are merely described below, by referring to the figures, to explain aspects and features of the present description.

The terms used in the disclosure are those selected from currently widely used general terms in consideration of functions in the disclosure. However, the terms may vary according to an engineer's intention, precedents, or advent of new technology. Also, for special cases, terms selected by the applicant are used, in which meanings the selected terms are described in detail in the description section. Accordingly, the disclosure will now be described more fully with reference to the accompanying drawings, in which embodiments of the disclosure are shown. In the following description, when detailed descriptions about related well-known functions or structures are determined to make the gist of the disclosure unclear, the detailed descriptions will be omitted herein or only briefly described herein.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

Two comparison objects being mentioned to be “the same” means that they are “substantially the same”. Accordingly, being substantially the same may include a case of having a deviation regarded as a low level in the field to which the disclosure pertains, for example, within 5%. Furthermore, a parameter being uniform in a certain area may mean being uniform from an average perspective.

Terms such as “first” and “second” are used herein merely to describe a variety of components, but the components are not limited by the terms. Such terms are used only for the purpose of distinguishing one component from another component. For example, without departing from the right scope of the disclosure, a first component may be referred to as a second component, and vice versa.

Thus, an expression used in a singular form in the specification also includes the expression in its plural form unless clearly specified otherwise in context.

When a component is disposed “above (or under)” or “on (or below)” to another component, not only the component may be only directly on an upper surface (or lower surface) of the other component, but also another component may be provided between the component and a certain component disposed on (or below) the other components.

Hereinafter, a battery pack 1, according to an embodiment of the present disclosure, is described with reference to the accompanying drawings.

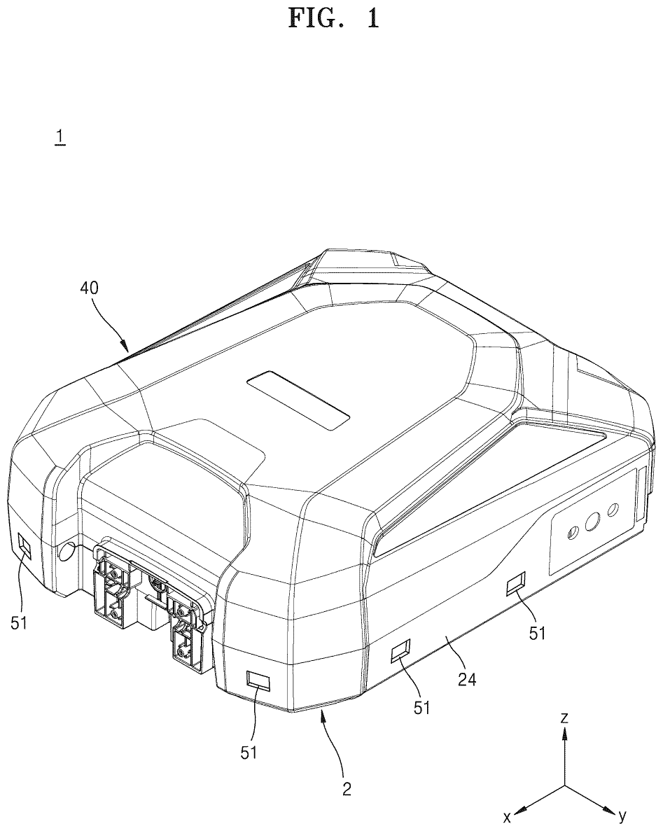

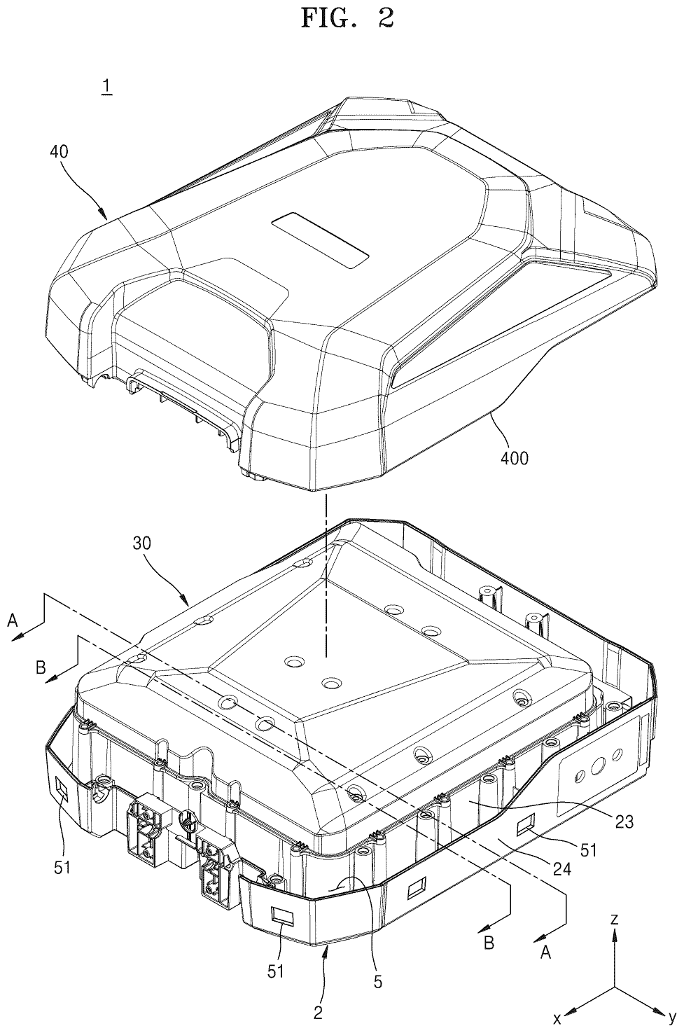

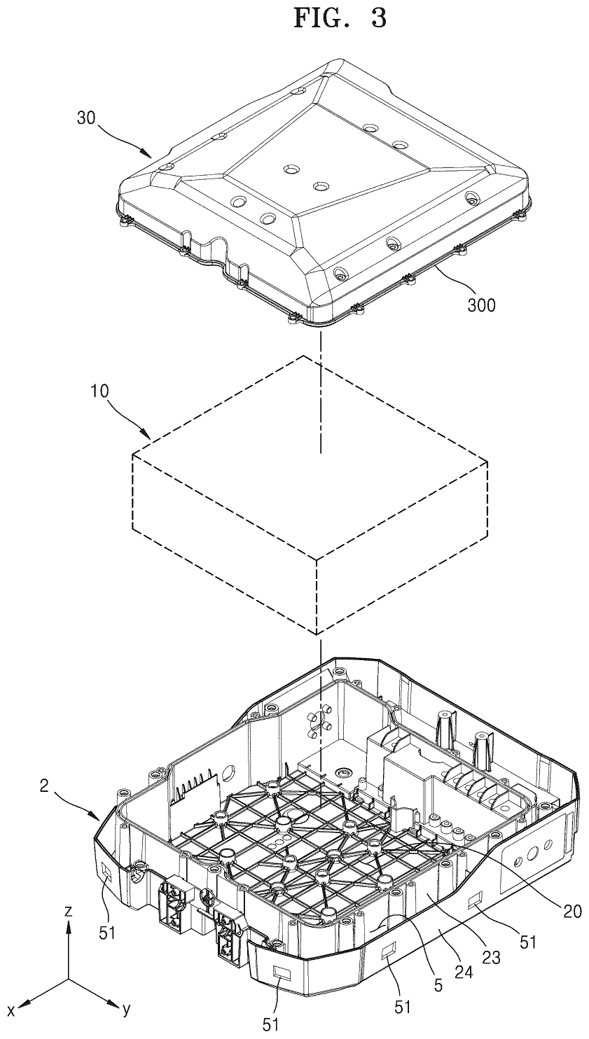

FIG. 1 is a perspective view of the battery pack 1 according to an embodiment. FIG. 2 is an exploded perspective view of the battery pack 1 according to an embodiment from which a second upper housing 40 is removed (or disassembled). FIG. 3 is an exploded perspective view of the battery pack 1 from which a first upper housing 30 is removed (or disassembled).

Referring to FIGS. 1 to 3, the battery pack 1, according to an embodiment, may include a lower housing 2, a first upper housing 30, and a second upper housing 40. The lower housing 2, the first upper housing 30, and the second upper housing 40 may protect a battery cell 10. The lower housing 2 may include an accommodation portion 20 that accommodates the battery cell 10. The battery cell 10 may be accommodated in the accommodation portion 20 of the lower housing 2. The first upper housing 30 may cover the accommodation portion 20 of the lower housing 2 from the top. The first upper housing 30 may be coupled to the lower housing 2. The first upper housing 30 may cover the battery cell 10 from the top. The second upper housing 40 may cover the first upper housing 30 from the top. The second upper housing 40 may be coupled to the lower housing 2. Thus, the battery cell 10 may be double protected by the first upper housing 30 and the second upper housing 40.

The lower housing 2, according to an embodiment, may have a first side wall 23. The first side wall 23 may define the accommodation portion 20 in the lower housing 2. The first side wall 23 extends upwardly from the lower housing 2 and may define a limitation of an outward direction of (e.g., may define an outer periphery of) the accommodation portion 20 arranged inside the first side wall 23. The first side wall 23 may prevent infiltration of fluid into the accommodation portion 20. The first side wall 23 may support the first upper housing 30. The above description of the first side wall 23 is only an example, and the disclosure is not limited thereto.

The lower housing 2, according to an embodiment, may include a second side wall 24. The second side wall 24 may be disposed to surround (e.g., to extend around a periphery of) the first side wall 23. The second side wall 24 may extend upwardly from the lower housing 2. The second side wall 24 may prevent infiltration of fluid into the battery pack 1. The second side wall 24 may support the second upper housing 40. The above description about the second side wall 24 is only an example, and the disclosure is not limited thereto.

The first side wall 23 and the second side wall 24, according to an embodiment, may waterproof the battery pack 1. The first side wall 23 and the second side wall 24 may prevent the battery cell 10 from being submerged in (or from contacting) a fluid that infiltrates from the outside of the battery pack 1. For example, the first side wall 23 and the second side wall 24 double cover the battery cell 10 and may waterproof the battery cell 10 (e.g., may ensure that water does not reach or contact the battery cell 10).

The first upper housing 30, according to an embodiment, may cover the accommodation portion 20 in the lower housing 2 from the top and may be coupled to the first side wall 23. The first upper housing 30 may include a first coupling portion 300 to be coupled to the first side wall 23. The first coupling portion 300 may extend downwardly from the first upper housing 30. The first coupling portion 300 may be coupled to the first side wall 23. The first coupling portion 300 of the first upper housing 30 is coupled to the first side wall 23 of the lower housing 2, thereby providing a waterproof seal around the accommodation portion 20 in which the battery cell 10 is accommodated. The waterproof seal provided to the accommodation portion 20 by first upper housing 30 and the lower housing 2 may prevent infiltration of fluid in a direction from the outside toward the inside of the accommodation portion 20.

The second upper housing 40, according to an embodiment, may cover the first upper housing 30 from the top and may be coupled to the second side wall 24. The second upper housing 40 may include a second coupling portion 400 to be coupled to the second side wall 24. The second coupling portion 400 may extend downwardly from the second upper housing 40. The second coupling portion 400 may be coupled to the second side wall 24. The second coupling portion 400 of the second upper housing 40, which is coupled to the second side wall 24 of the lower housing 2, may provide a second (or outer) waterproof seal to the accommodation portion 20 in which the battery cell 10 is accommodated. The provision of dual waterproof seals to the accommodation portion 20 may further prevent infiltration of fluid through a gap between the first coupling portion 300 of the first upper housing 30 and the first side wall 23 of the lower housing 2.

In the following description, lengths of the first side wall 23 and the second side wall 24 extending upwardly from the lower housing 2 are described, in detail, in connection with the waterproof seal provided by the first side wall 23 and the second side wall 24.

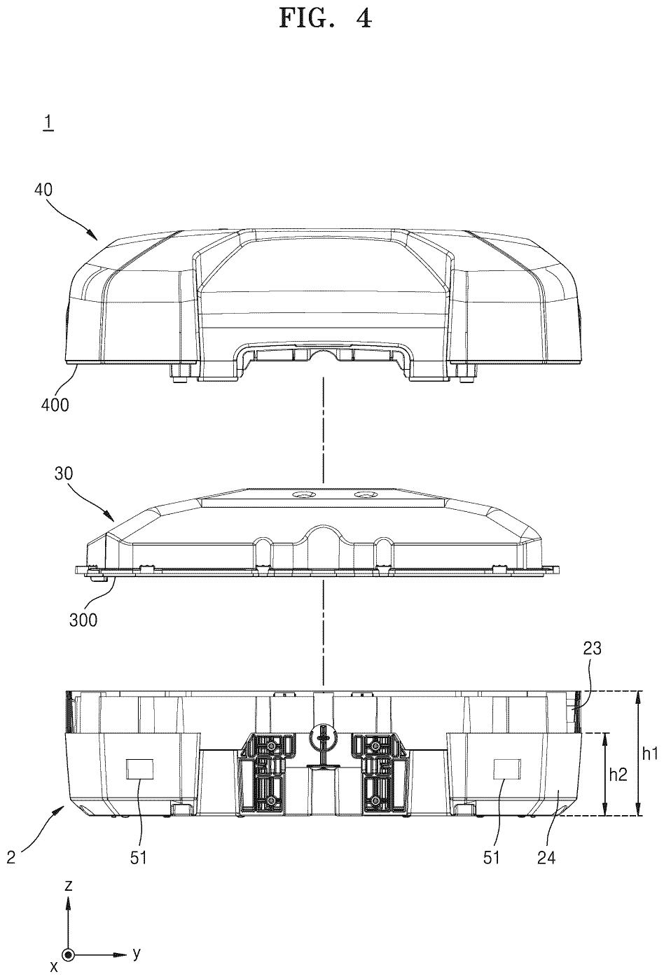

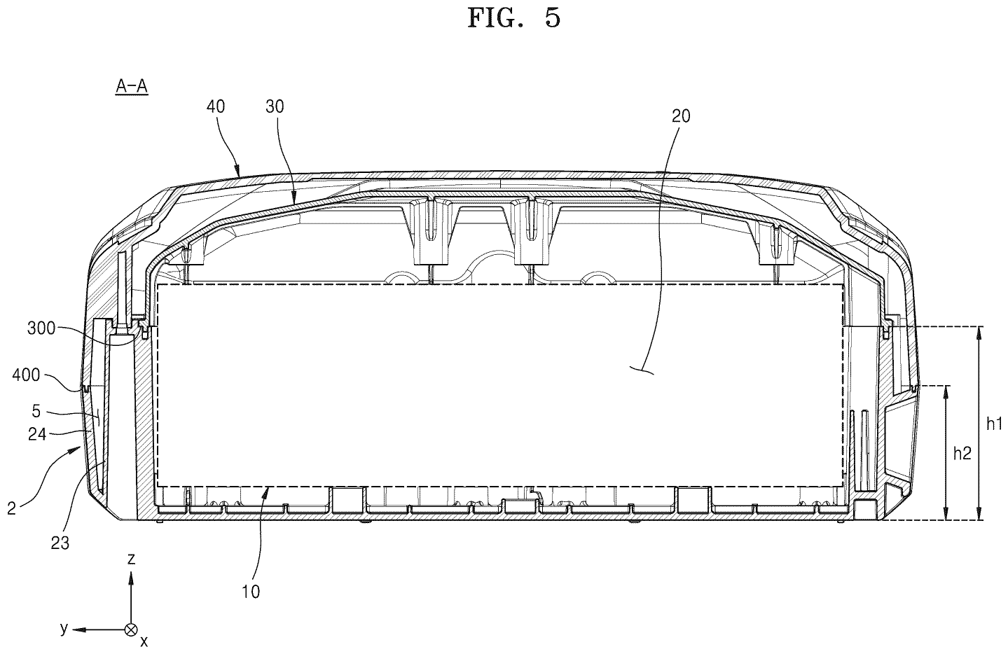

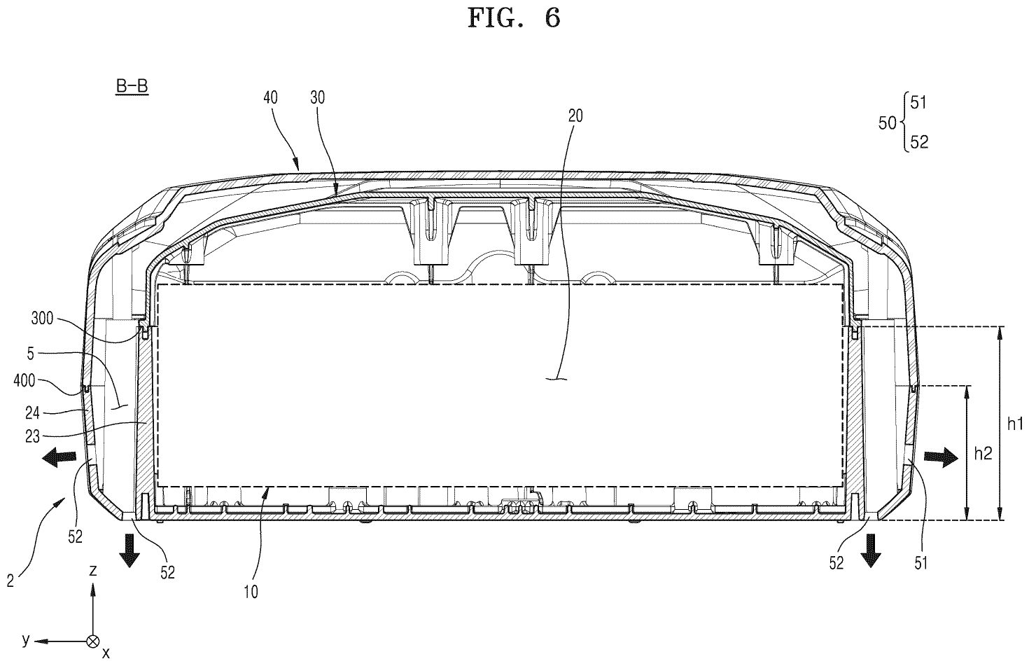

FIG. 4 is an exploded perspective view of the battery pack 1 according to an embodiment. FIG. 5 is a cross-sectional view of the battery pack 1 taken along the line A-A in FIG. 2. FIG. 6 is a cross-sectional view of the battery pack 1 taken along the line B-B in FIG. 2.

Referring to FIGS. 2 to 6, the first side wall 23 and the second side wall 24 of the lower housing 2, according to an embodiment, may each extend upwardly by a length. The length of first side wall 23 extending upwardly may be greater than the length of the second side wall 24 extending upwardly. The length of the second side wall 24 extending upwardly may be less than the length of the first side wall 23 extending upwardly. The length of the first side wall 23 and the second side wall 24 extending upwardly may be a length measured from a lower end of the battery pack 1 to each of an end portion of the first side wall 23 and an end portion of the second side wall 24. An upper end of the first side wall 23 may be disposed above an upper end of the second side wall 24. The upper end of the first side wall 23 may be disposed above the upper end of the second side wall 24 along the entire periphery thereof. For example, the upper end of the first side wall 23 may be disposed above the upper end of the second side wall 24 arranged corresponding thereto. The upper end of the first side wall 23 being disposed above the upper end of the second side wall 24 and, therefore, may prevent a fluid flowing into the battery pack 1 at the second side wall 24 from flowing into the battery cell 10.

A height h1, in which the first upper housing 30 is coupled to the first side wall 23, may be different from a height h2 in which the second upper housing 40 is coupled to the second side wall 24. For example, the height h1 in which the first upper housing 30 is coupled to the first side wall 23 may be greater than the height h2 in which the second upper housing 40 is coupled to the second side wall 24. The first coupling portion 300 may be coupled to the upper end of the first side wall 23. The second coupling portion 400 may be coupled to the upper end of the second side wall 24. The height h1 in which first upper housing 30 is coupled to the first side wall 23 being greater than the height h2 in which the second upper housing 40 is coupled to the second side wall 24 may be because the height h1 of the upper end of the first side wall 23 is greater than the height h2 of the upper end of the second side wall 24. The height h1 in which the first coupling portion 300 is coupled to the first side wall 23 being greater than the height h2 in which the second coupling portion 400 is coupled to the second side wall 24 may prevent a fluid flowing between the second coupling portion 400 and the second side wall 24 from the outside of the battery pack 1 from flowing into the accommodation portion 20 that accommodates the battery cell 10 through a gap between the first coupling portion 300 and the first side wall 23.

The first side wall 23 and the second side wall 24, according to an embodiment, may be spaced apart from each other by a distance. An air gap 5 may be formed at where the first side wall 23 and the second side wall 24 are spaced apart from each other. A fluid flowing between the first coupling portion 300 of the first upper housing 30 and the first side wall 23 from the outside of the battery pack 1 may move downwardly through the air gap 5. The air gap 5 may prevent the fluid flowing between the second coupling portion 400 of the second upper housing 40 and the second side wall 24 from the outside of the battery pack 1 from flowing between the first coupling portion 300 of the first upper housing 30 and the first side wall 23. Because the air gap 5 exists between the first side wall 23 and the second side wall 24, the accommodation portion 20 that accommodates the battery cell 10 may be protected by a dual waterproof seal.

In the following description, a drain hole configured to discharge (or drain) a fluid in into the air gap is described.

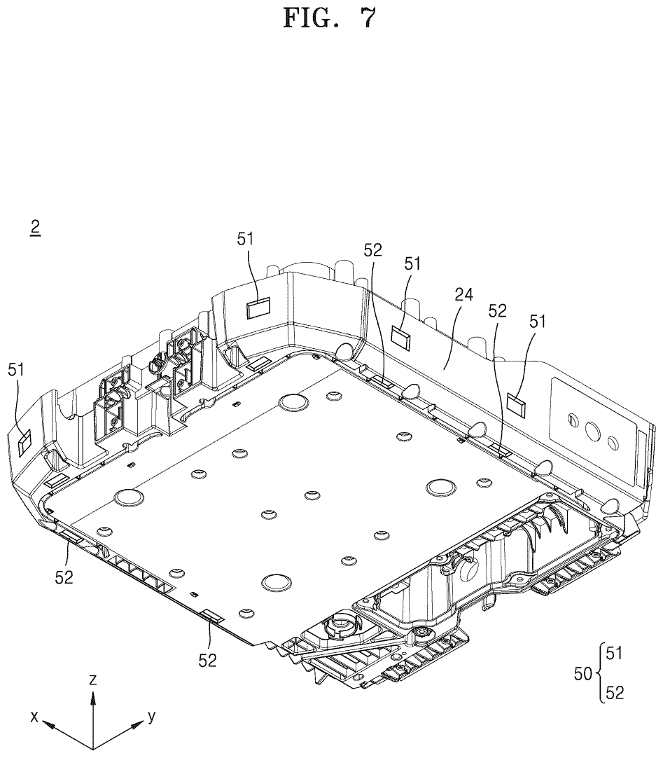

FIG. 7 is a perspective bottom view of the lower housing 2 according to an embodiment.

Referring to FIGS. 2 to 7, the lower housing 2, according to an embodiment, may include a drain hole 50 configured to discharge (or drain) a fluid flowing into the air gap 5 from the outside of the battery pack 1. The drain hole 50 may be connected to (e.g., may be in fluid communication with) the air gap 5. The fluid flowing between the second coupling portion 400 of the second upper housing 40 and the first side wall 23 from the outside of the battery pack 1 may be discharged to the outside of the battery pack 1 through the drain hole 50 connected to the air gap 5. The drain hole 50 may prevent the fluid flowing from the outside of the battery pack 1 from being stored in (or retained in) battery pack 1.

The drain hole 50, according to an embodiment, may penetrate (or may extend through) an outer wall of the lower housing 2 to allow the air gap 5 to be connected to the outside of the battery pack 1. The drain hole 50 may include a plurality of drain holes. The drain hole 50 may include a first drain hole 51 arranged in a side portion (e.g., a side wall) of the lower housing 2. The drain hole 50 may include a second drain hole 52 arranged in a lower portion (e.g., a floor or base) of the housing 2. The first drain hole 51 and the second drain hole 52 may be formed in the lower housing 2 in two directions substantially perpendicular to each other. When the first drain hole 51 and the second drain hole 52 are formed in the lower housing 2 in directions substantially perpendicular to each other, the drain hole 50 may further prevent the fluid flowing from the outside of the battery pack 1 from being stored in the air gap 5.

The first drain hole 51 and the second drain hole 52 may respectively include a plurality of first drain holes and a plurality of second drain holes. The first drain holes 51 may be spaced apart from each other by a distance. The second drain hole 52 may be spaced apart from each other by a distance. The size and arrangement of the drain hole 50 as shown in FIG. 7 is merely an example to explain the drain hole 50, and other embodiments of the present disclosure may have drain holes of various sizes and arrangements to drain water from the battery pack 1.

The battery pack, according to an embodiment, may have a dual waterproof seal around the accommodation portion that accommodates a battery cell.

The battery pack, according to an embodiment, may discharge a fluid flowing into the battery pack to the outside.

It should be understood that the embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. A battery pack comprising:
a battery cell;
a lower housing having an accommodation portion accommodating the battery cell, a first side wall extending around a periphery of the battery cell and defining the accommodation portion, and a second side wall extending around a periphery of the first side wall;
a first upper housing covering the accommodation portion from above and coupled to the first side wall; and
a second upper housing covering the first upper housing from above and coupled to the second side wall,
wherein an upper end of the first side wall is above an upper end of the second side wall.

2. The battery pack as claimed in claim 1, wherein a height at which the first upper housing is coupled to the first side wall is different from a height at which the second upper housing is coupled to the second side wall.

3. The battery pack as claimed in claim 2, wherein the first upper housing comprises a first coupling portion coupled to the first side wall,
wherein the second upper housing comprises a second coupling portion coupled to the second side wall, and
wherein the first coupling portion is above the second coupling portion.

4. The battery pack as claimed in claim 1, wherein the first side wall and the second side wall are spaced apart from each other by a distance.

5. The battery pack as claimed in claim 4, wherein an air gap is formed between the first side wall and the second side wall.

6. The battery pack as claimed in claim 5, wherein the lower housing has a drain hole configured to discharge a fluid flowing into the air gap from outside the battery pack.

7. The battery pack as claimed in claim 6, wherein the drain hole penetrates an outer wall of the lower housing such that the air gap is connected to the outside of the battery pack.

8. The battery pack as claimed in claim 7, wherein the drain hole is in a side portion of the lower housing.

9. The battery pack as claimed in claim 7, wherein the drain hole a lower portion of the lower housing.

10. The battery pack as claimed in claim 7, wherein the drain hole comprises:
a plurality of first drain holes in a side portion of the lower housing; and
a plurality of second drain holes in a lower portion of the lower housing.

11. The battery pack as claimed in claim 10, wherein the plurality of first drain holes and the plurality of second drain holes are extend through the lower housing in directions substantially perpendicular to each other.
